(19) United States
(12) Patent Application Publication
(10) Pub. No.: US 2026/0189961 A1
(43) Pub. Date: Jul. 2, 2026

(54) TRANSMITTING AND RECEIVING MEASUREMENT REPORT MAC CE

(71) Applicant: Samsung Electronics Co., Ltd., Suwon-si (KR)

(72) Inventor: Anil Agiwal, McKinney, TX (US)

(21) Appl. No.: 19/422,273

(22) Filed: Dec. 16, 2025

Related U.S. Application Data
(60) Provisional application No. 63/739,436, filed on Dec. 27, 2024.

(51) Int. Cl. H04W 24/10; H04B 7/06

(52) U.S. Cl. CPC H04W 24/10; H04B 7/06952

(57) ABSTRACT

A method of operating a UE includes detecting that an L1 measurement report for at least one beam of a plurality of beams of one or more cells exceeds a threshold time, and in response to detection of the event exceeding the threshold time, determining whether an UL grant can accommodate an L1 measurement report MAC control element CE including measurement reporting information of the plurality of beams, the plurality of beams including (i) beams corresponding with the event exceeding the threshold time, and (ii) beams that do not correspond with the event exceeding the threshold time. The method also includes based on a result of the determination, generating one of an L1 measurement report MAC CE or a truncated L1 measurement report MAC CE; and transmitting, to a BS, the one of the L1 measurement report MAC CE or the truncated L1 measurement report MAC CE.

### CROSS-REFERENCE TO RELATED APPLICATION(S) AND CLAIM OF PRIORITY

This application claims priority under 35 U.S.C. § 119(e) to U.S. Provisional Ser. No. 63/739,436 filed on Dec. 27, 2024. The above-identified provisional patent application is hereby incorporated by reference in its entirety.

### TECHNICAL FIELD

This disclosure relates generally to wireless networks. More specifically, this disclosure relates to apparatuses and methods for transmitting and receiving measurement report (MR) medium access control (MAC) control elements (CEs).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods for transmitting and receiving MR MAC CEs.

In one embodiment, a user equipment (UE) is provided. The UE includes a processor configured to detect that an event triggering a layer 1 (L1) measurement report for at least one beam of a plurality of beams of one or more cells exceeds a threshold time, and in response to detection of the event exceeding the threshold time, determine a first determination whether an uplink (UL) grant can accommodate an L1 measurement report medium access control (MAC) control element (CE) including measurement reporting information of the plurality of beams, the plurality of beams including (i) beams corresponding with the event exceeding the threshold time, and (ii) beams that do not correspond with the event exceeding the threshold time. The processor is also configured to based on a result of the first determination, generate one of an L1 measurement report MAC CE or a truncated L1 measurement report MAC CE. The UE also includes a transceiver operably coupled to the processor. The transceiver is configured to transmit, to a base station (BS), the one of the L1 measurement report MAC CE or the truncated L1 measurement report MAC CE.

In another embodiment, a method of operating a UE is provided. The method includes detecting that an event triggering an L1 measurement report for at least one beam of a plurality of beams of one or more cells exceeds a threshold time, and in response to detection of the event exceeding the threshold time, determining a first determination whether an UL grant can accommodate an L1 measurement report MAC CE including measurement reporting information of the plurality of beams, the plurality of beams including (i) beams corresponding with the event exceeding the threshold time, and (ii) beams that do not correspond with the event exceeding the threshold time. The method also includes based on a result of the first determination, generating one of an L1 measurement report MAC CE or a truncated L1 measurement report MAC CE; and transmitting, to a BS, the one of the L1 measurement report MAC CE or the truncated L1 measurement report MAC CE.

In yet another embodiment, A non-transitory computer readable medium embodying a computer program is provided. The computer program includes program code that, when executed by a processor of a device, causes the device to detect that an event triggering a L1 measurement report for at least one beam of a plurality of beams of one or more cells exceeds a threshold time, and in response to detection of the event exceeding the threshold time, determine a first determination whether an UL grant can accommodate an L1 measurement report medium access control MAC CE including measurement reporting information of the plurality of beams, the plurality of beams including (i) beams corresponding with the event exceeding the threshold time, and (ii) beams that do not correspond with the event exceeding the threshold time. The program code, when executed by the processor of the device, also causes the device to, based on a result of the first determination, generate one of an L1 measurement report MAC CE or a truncated L1 measurement report MAC CE, and transmit, to a BS, the one of the L1 measurement report MAC CE or the truncated L1 measurement report MAC CE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for generating an MR MAC CE for event-triggered L1-measurements reporting according to embodiments of the present disclosure;

FIG. 5 illustrates another example procedure for generating an MR MAC CE for event-triggered L1-measurements reporting according to embodiments of the present disclosure; and

FIG. 6 illustrates an example method for transmitting and receiving an MR MAC CE according to embodiments of the present disclosure.

### DETAILED DESCRIPTION

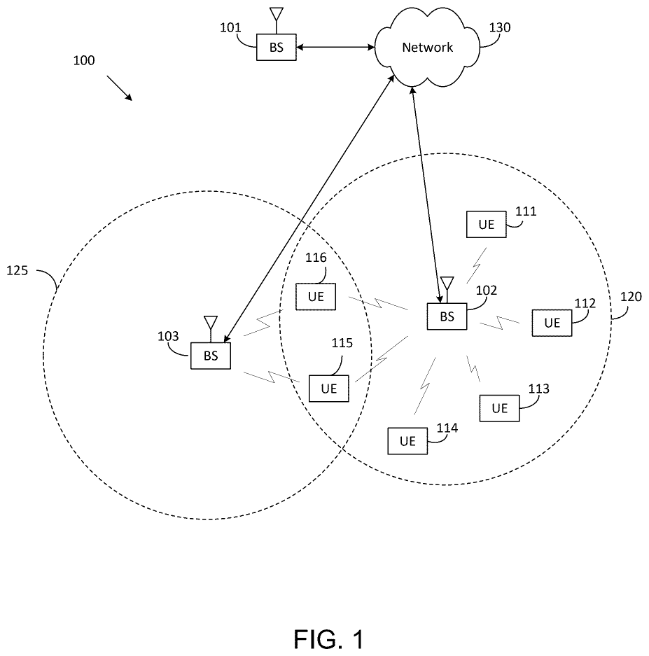

FIGS. 1 through 6, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for transmitting and receiving measurement report MAC CEs. In certain embodiments, one or more of the gNBs 101-103 includes circuitry, programing, or a combination thereof, to support transmitting and receiving measurement report MAC CEs in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

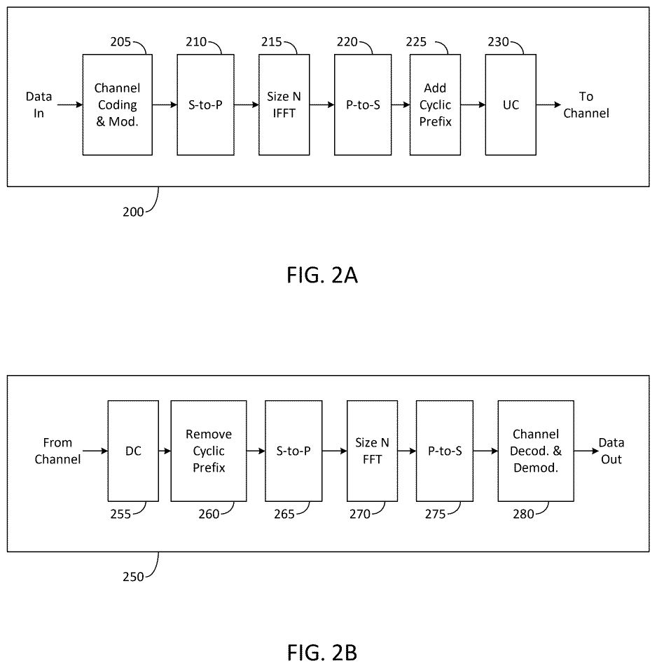

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support transmitting and receiving measurement report MAC CEs as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

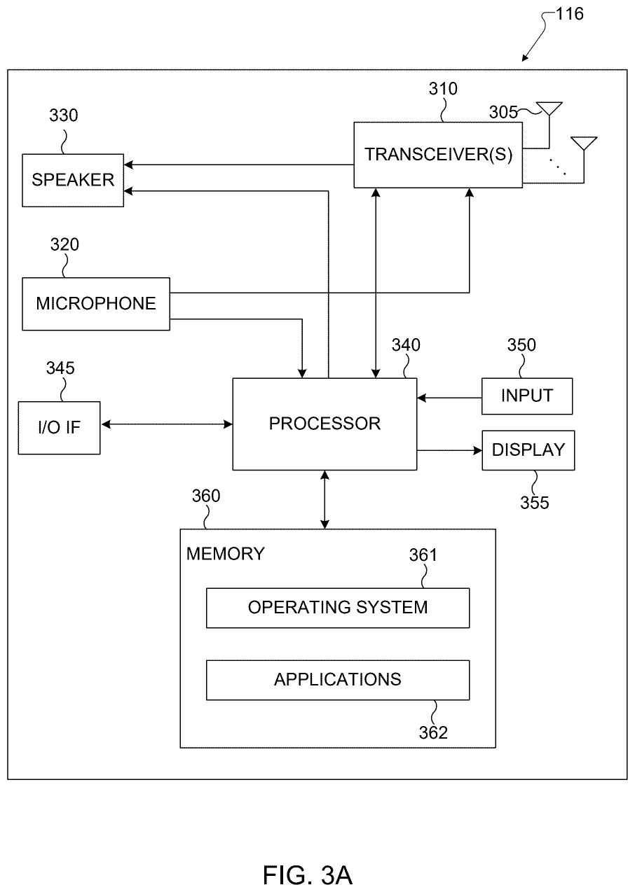

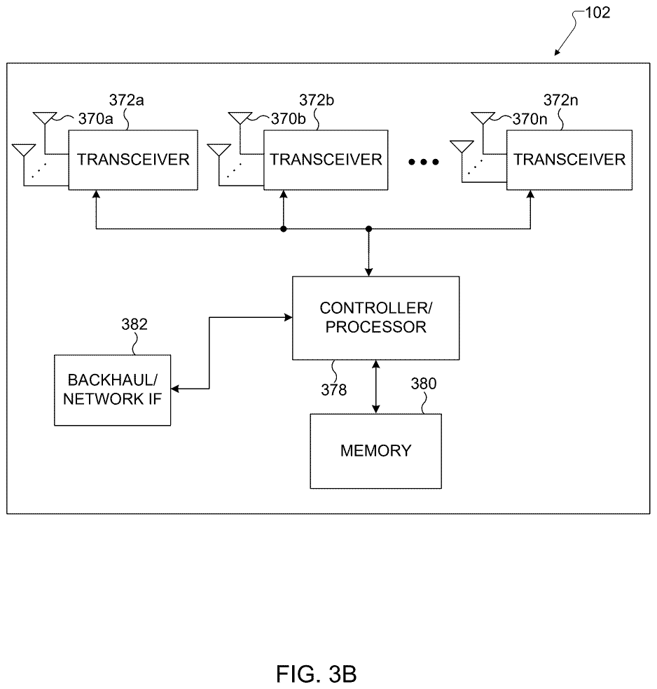

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for transmitting and receiving measurement report MAC CEs as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support transmitting and receiving measurement report MAC CEs as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network (CN). NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot) mod (Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G (B5G), 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random-access procedure are supported such as contention based random access, contention free random access and each of these can be one of 2 step or 4 step random access.

In contention based random access (CBRA), also referred as 4 step CBRA, the UE first transmits a Random Access preamble (also referred to as Msg1) and then waits for a Random access response (RAR) in the RAR window. The RAR is also referred to as Msg2. A next generation node B (gNB) transmits the RAR on the physical downlink shared channel (PDSCH). A PDCCH scheduling the PDSCH carrying the RAR is addressed to a RA-radio network temporary identifier (RA-RNTI). The RA-RNTI identifies the time-frequency resource (also referred to as a physical RA channel [PRACH] occasion or PRACH transmission [TX] occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted the Msg1, (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for a normal UL [NUL] carrier and 1 for a supplementary UL [SUL] carrier. Several RARs for various Random-access preambles detected by the gNB can be multiplexed in the same RAR media access control (MAC) protocol data unit (PDU) by the gNB. A RAR in MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step (i.e., select a random access resource [preamble/RACH occasion]) and transmits the RA preamble. A backoff may be applied before going back to first step.

If the RAR corresponding to its RA preamble transmission is received, the UE transmits a message 3 (Msg3) in the UL grant received in the RAR. The Msg3 includes a message such as an RRC connection request, RRC connection re-establishment request, RRC handover confirm, scheduling request, SI request etc. It may include the UE identity (i.e., cell-radio network temporary identifier [C-RNTI] or system architecture evolution [SAE]-temporary mobile subscriber identity [S-TMSI] or a random number). After transmitting the Msg3, the UE starts a contention resolution timer. While the contention resolution timer is running, if UE receives a physical downlink control channel (PDCCH) addressed to the C-RNTI included in the Msg3, contention resolution is considered successful, the contention resolution timer is stopped, and the RA procedure is completed. While the contention resolution timer is running, if the UE receives a contention resolution MAC control element (CE) including the UE's contention resolution identity (first X bits of common control channel [CCCH] service data unit [SDU] transmitted in the Msg3), contention resolution is considered successful, the contention resolution timer is stopped, and the RA procedure is completed. If the contention resolution timer expires and the UE has not yet transmitted the RA preamble for a configurable number of times, the UE goes back to the first step (i.e., select random access resource [preamble/RACH occasion]) and transmits the RA preamble. A backoff may be applied before going back to first step.

Contention free random access (CFRA), also referred to as legacy CFRA or 4 step CFRA, is used for scenarios such as handover where low latency is required, timing advance establishment for secondary cell (Scell), etc. An evolved node B (eNB) assigns to the UE a dedicated Random access preamble. The UE transmits the dedicated RA preamble. The eNB transmits the RAR on a PDSCH addressed to a RA-RNTI. The RAR conveys an RA preamble identifier and timing alignment information. The RAR may also include an UL grant. The RAR is transmitted in RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if a PDCCH addressed to a C-RNTI is received in the search space for beam failure recovery. If the RAR window expires and the RA is not successfully completed and the UE has not yet transmitted the RA preamble for a configurable (configured by the gNB in a RACH configuration) number of times, the UE retransmits the RA preamble.

For certain events such as handover and beam failure recovery if dedicated preamble(s) are assigned to UE, during first step of random access (i.e., during random access resource selection for Msg1 transmission) the UE determines whether to transmit a dedicated preamble or non-dedicated preamble. Dedicated preambles are typically provided for a subset of SSBs/CSI RSs. If there are no SSB/CSI RS having a DL RSRP above a threshold amongst the SSBs/CSI RSs for which contention free random access resources (i.e., dedicated preambles/ROs) are provided by the gNB, the UE selects a non-dedicated preamble. Otherwise, the UE selects a dedicated preamble. During the RA procedure, one random access attempt can be CFRA while other random access attempts can be CBRA.

For 2 step contention based random access (2 step CBRA), in the first step, the UE transmits a random access preamble on a PRACH and a payload (i.e., MAC PDU) on a PUSCH. The random access preamble and payload transmission is also referred to as a message A (MsgA). In the second step, after the MsgA transmission, the UE monitors for a response from the network (i.e., a gNB) within a configured window. The response is also referred to as a message B (MsgB). A gNB transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion orRACH occasion) in which the RA preamble was detected by the gNB. The MSGB -RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where UE has transmitted the MsgA (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier).

If a CCCH SDU was transmitted in the MsgA payload, the UE performs contention resolution using the contention resolution information in the MsgB. The contention resolution is successful if the contention resolution identity received in the MsgB matches the first 48 bits of the CCCH SDU transmitted in the MsgA. If a C-RNTI was transmitted in the MsgA payload, the contention resolution is successful if the UE receives a PDCCH addressed to the C-RNTI. If contention resolution is successful, the random access procedure is considered successfully completed. Instead of contention resolution information corresponding to the transmitted MsgA, the MsgB may include fallback information corresponding to the random access preamble transmitted in the MsgA. If the fallback information is received, the UE transmits a Msg3 and performs contention resolution using a Msg4 as in CBRA procedure. If the contention resolution is successful, the random access procedure is considered successfully completed. If the contention resolution fails upon fallback (i.e., upon transmitting the Msg3), the UE retransmits the MsgA. If the configured window in which the UE monitors for a network response after transmitting the MsgA expires and the UE has not received a MsgB including contention resolution information or fallback information as explained above, the UE retransmits MsgA. If the random access procedure is not successfully completed even after transmitting the MsgA configurable number of times, the UE falls back to the 4 step RACH procedure (i.e., the UE only transmits the PRACH preamble).

A MsgA payload may include one or more of a CCCH SDU, dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding. The MsgA may include a UE ID (e.g., a random ID, S-TMSI, C-RNTI, resume ID, etc.) along with a preamble in the first step. The UE ID may be included in the MAC PDU of the MsgA. AUE ID such as a C-RNTI may be carried in the MAC CE, wherein the MAC CE is included in The MAC PDU. Other UE IDs (such as a random ID, S-TMSI, C-RNTI, resume ID, etc.) may be carried in a CCCH SDU. The UE ID can be one of a random ID, S-TMSI, C-RNTI, resume ID, IMSI, idle mode ID, inactive mode ID, etc. The UE ID can be different in different scenarios in which the UE performs the RA procedure. When the UE performs RA after power on (before the UE is attached to the network), then the UE ID is the random ID. When the UE performs an RA in an IDLE state after the UE is attached to network, the UE ID is an S-TMSI. If the UE has an assigned C-RNTI (e.g., in a connected state), the UE ID is the C-RNTI. In case the UE is in an INACTIVE state, the UE ID is a resume ID. In addition to the UE ID, some addition control information can be sent in a MsgA. The control information may be included in the MAC PDU of the MsgA. The control information may include one or more of a connection request indication, connection resume request indication, SI request indication, buffer status indication, beam information (e.g., one or more DL TX beam ID[s] or SSB ID[s]), beam failure recovery indication/information, data indicator, cell/BS/TRP switching indication, connection re-establishment indication, reconfiguration complete or handover complete message, etc.

In the case of 2 step contention free random access (2 step CFRA), the gNB assigns to the UE dedicated random access preamble(s) and PUSCH resource(s) for MsgA transmission. RACH occasions (ROs) to be used for preamble transmission may also be indicated. In the first step, the UE transmits a random access preamble on a PRACH and a payload on a PUSCH using the contention free random access resources (i.e., dedicated preamble/PUSCH resource/RO). In the second step, after the MsgA transmission, the UE monitors for a response from the network (i.e., gNB) within a configured window. The response is also referred to as a MsgB.

A gNB transmits the MsgB on a PDSCH. A PDCCH scheduling the PDSCH carrying the MsgB is addressed to a MsgB-radio network temporary identifier (MSGB-RNTI). The MSGB-RNTI identifies the time-frequency resource (also referred to as a PRACH occasion or PRACH TX occasion or RACH occasion) in which the RA preamble was detected by the gNB. The MSGB-RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where the UE has transmitted the Msg 1 (i.e., RA preamble); 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for an NUL carrier and 1 for an SUL carrier).

If the UE receives a PDCCH addressed to the C-RNTI, the random access procedure is considered successfully completed. If the UE receives fallback information corresponding to its transmitted preamble, the random access procedure is considered successfully completed.

Event-triggered layer 1 (L1)-measurements are supported in wireless networks to facilitate mobility. These event-triggered L1-measurements can be used by the network to select the candidate beam/cell with which to trigger early synchronization. These event-triggered L1-measurements can also be used by the network to select the target beam/cell and trigger a lower layer triggered mobility (LTM) cell switch procedure. Event-triggered L1-measurements are reported by the UE to the network via a medium access control (MAC) control element (CE). In some embodiments, event-triggered L1-measurements reporting can be triggered based on following events:
Event LTM2: the beam of a serving cell becomes worse than an absolute threshold;
Event LTM3: the beam of a candidate cell becomes an amount of offset better than beam of serving cell;
Event LTM4: the beam of a candidate cell becomes better than an absolute threshold;
Event LTM5: the beam of a serving cell becomes worse than an absolute threshold 1 AND the beam of a candidate cell becomes better than another absolute threshold 2.

In some embodiments, an L1-referennce signal received power (RSRP) or signal to interference plus noise (SINR) ratio of N beams is included in the MAC CE. N is configured by the network. When the UE generates the MAC CE for event-triggered L1-measurements reporting, event-triggered L1-measurements reporting may be triggered and pending for several beams of one or more cells. The L1-RSRP or SINR of N beams per cell is included in the MAC CE. Due to limited UL grant size, it may not be possible to include information of all N beams of all cells for which L1-measurements reporting is pending. Various embodiments of the present disclosure provide for generation of a truncated MAC CE including truncated information of all of the N beams or all cells for which L1-measurements reporting is pending. Various embodiments of the present disclosure also provide for identification of which information is truncated and which information is prioritized to be included in the MAC CE.

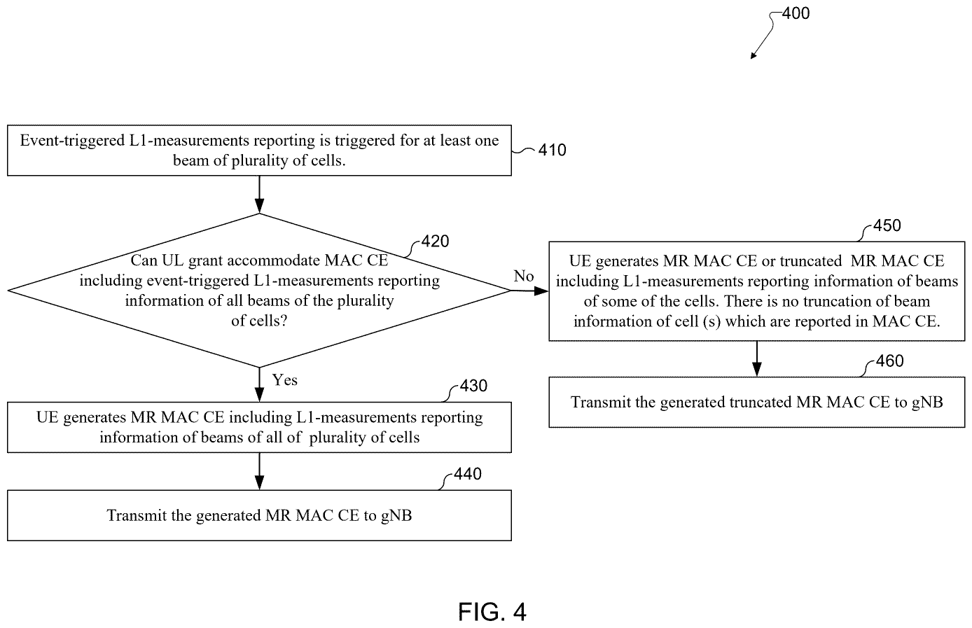

FIG. 4 illustrates an example procedure for generating an MR MAC CE for event-triggered L1-measurements reporting 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for generating an MR MAC CE for event-triggered L1-measurements reporting could be used without departing from the scope of this disclosure.

In the example of FIG. 4, the process begins at operation 410. At operation 410, an event-triggered L1-measurements reporting for a UE (such as UE 116 of FIG. 1) is triggered for at least one beam of a plurality of cells. The event-triggered L1-measurements reporting is triggered if the event configured for the beam is met and continues to be met for a time interval equal to ‘time to trigger’. This time interval may also be referred to a threshold time.

At operation 420, the UE checks if a UL grant for the event-triggered L1-measurements reporting can accommodate a MAC CE (the MAC CE may include a MAC sub PDU and MAC sub header) including event-triggered L1-measurements reporting information for the beams of the pluralities of cells. If the UL grant can accommodate the event-triggered L1-measurements reporting information for the beams of the pluralities of cells, then procedure 400 proceeds to operation 430. Otherwise, if the UL grant cannot accommodate the event-triggered L1-measurements reporting information for the beams of the pluralities of cells, then procedure 400 proceeds to operation 450.

At operation 430, the UE generates a measurement report (MR) MAC CE including L1-measurements reporting information of beams of the plurality of cells. In embodiments such as these, the L1-RSRP or SINR of up to N beams per cell is included in the MAC CE. N is configured by the network and is equal to a maximum number of beams whose information can be included in the report. If X is the number of beams in a cell, the number of beams (K) per cell whose information can be included in the report may be equal to a minimum of (N, X). N can be equal to the number of beams for which an event is met, and other beams for which the event is not met, if any (for the case N is greater than the number of beams for which the event is met). If the number of other beams for which event is not met is greater than ‘N—number of beams for which event is met’, the UE selects the best (in terms of signal strength [i.e., L1-RSRP or SINR, RSSI, etc.]) ‘N—number of beams for which the event is met’ of other beams to report in the MR MAC CE. If X is the number of transmitted beams in a cell, the number of beams whose information can be included in the report is equal to a minimum of (N, X). The UE then transmits the generated MR MAC CE to the gNB at operation 440.

At operation 450, the UE generates an MR MAC CE or truncated MR MAC CE including L1-measurements reporting information of beams of some the cells. There is no truncation of beam information of cell(s) which are reported in MAC CE. In embodiments such as these, the L1-RSRP or SINR of up to N beams per cell is included in the MAC CE. N is configured by the network and is equal to maximum number of beams whose information can be included in the report. If X is the number of beams in a cell, the number of beams (K) per cell whose information can be included in the report may be equal to minimum of (N, X). N equals the number of beams for which event is met, plus other beams for which the event is not met (for the case N is greater than the number of beams for which the event is met). If a number of other beams for which the event is not met is greater than ‘N—number of beams for which event is met’, The UE selects the best (in terms of signal strength [i.e., L1-RSRP or SINR, RSSI, etc.]) ‘N—number of beams for which the event is met’ of other beams to report in the MR MAC CE. For example, if an MR is triggered for beams of X (where X is greater than 1) cells and the UE includes a MR for beams of Y cells (for example, Y<X e.g. Y=1, 2, . . . X−1) in one MR MAC CE due to lack of sufficient UL grant size. The UE then transmits the generated MR MAC CE or truncated MR MAC CE to the gNB at operation 460.

Although FIG. 4 illustrates one example method for generating an MR MAC CE for event-triggered L1-measurements reporting 400, various changes may be made to FIG. 4. For example, while shown as a series of operations, various operations in FIG. 4 could overlap, occur in parallel, occur in a different order, occur any number of times, be omitted, or replaced by other operations.

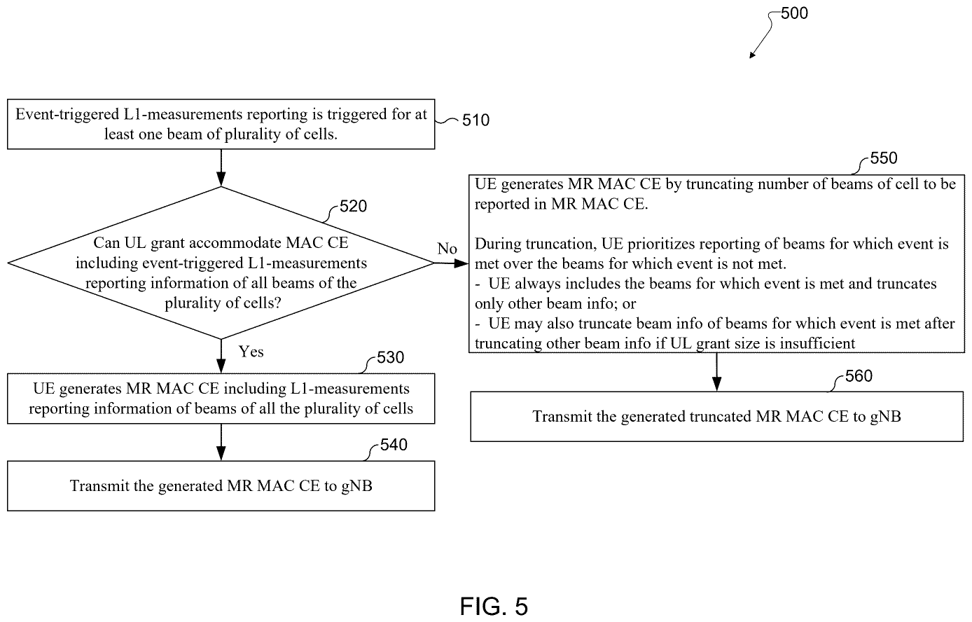

FIG. 5 illustrates another example procedure for generating an MR MAC CE for event-triggered L1-measurements reporting 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for generating an MR MAC CE for event-triggered L1-measurements reporting could be used without departing from the scope of this disclosure.

In the example of FIG. 5, the process begins at operation 510. At operation 510, an event-triggered L1-measurements reporting for a UE (such as UE 116 of FIG. 1) is triggered for at least one beam of a plurality of cells. The event-triggered L1-measurements reporting is triggered if the event configured for the beam is met and continues to be met for a time interval equal to ‘time to trigger’. This time interval may also be referred to a threshold time.

At operation 520, the UE checks if a UL grant for the event-triggered L1-measurements reporting can accommodate a MAC CE (the MAC CE may include a MAC sub PDU and MAC sub header) including event-triggered L1-measurements reporting information for the beams of the pluralities of cells. If the UL grant can accommodate the event-triggered L1-measurements reporting information for the beams of the pluralities of cells, then procedure 500 proceeds to operation 530. Otherwise, if the UL grant cannot accommodate the event-triggered L1-measurements reporting information for the beams of the pluralities of cells, then procedure 500 proceeds to operation 550.

At operation 530, the UE generates a MR MAC CE including L1-measurements reporting information of beams of the plurality of cells. In embodiments such as these, the L1-RSRP or SINR of up to N beams per cell is included in the MAC CE. N is configured by the network and is equal to a maximum number of beams whose information can be included in the report. If X is the number of beams in a cell, the number of beams (K) per cell whose information can be included in the report may be equal to a minimum of (N, X). N, or the number of beams whose information can be included in the report equals the number of beams for which the event is met, plus other beams for which the event is not met (for the case N is greater than the number of beams for which the event is met), if any. If the number of other beams for which the event is not met is greater than ‘N (or K)—number of beams for which event is met’, the UE selects the best ‘N (or K)—numberof beams for which the event is met’ of other beams to report in the MR MAC CE. The UE then transmits the generated MR MAC CE to the gNB at operation 540.

At operation 550, the UE generates an MR MAC CE or truncated MR MAC CE by truncating the number of beams of cell to be reported in the MR MAC CE. The UE may exclude reporting some beams in the MR of a cell if the UL grant size is insufficient. For example, if N is 4, the UE may report less than 4 beams. During truncation, the UE prioritizes reporting beams for which the event is met over the beams for which the event is not met. For example, if N is 4 (i.e., the UE can report information of up to 4 beams) and the event is met for beams b1 and b2, the UE prioritizes reporting beams b1 and b2 over other beams if the UL grant size is insufficient to include information of other beams.

In some embodiments, the UE always includes the beams for which the event is met and truncates only other beam info; or alternatively, in some other embodiments, the UE may also truncate beam information of beams for which the event is met after truncating other beam information if the UL grant size is insufficient. For example, if N is 4 (i.e., the UE can report information of up to 4 beams) and the event is met for beams b1, b2 and b3, the UE may report information of b1 if the UL grant size is insufficient to include information of b2 and b3. The UE may truncate the beam information of beams based on the time reporting was triggered (e.g., the beam for which reporting was triggered later may be truncated [i.e., the UE may include beam information of beams in ascending order (earliest to latest) of the reporting time]). Alternately, in some embodiments, the UE may truncate the beam information of beams based on the time reporting was triggered (e.g., the beam for which reporting was triggered earlier may be truncated [i.e., the UE includes beam information of beams in descending order (latest to earliest) of the reporting time]).

In some embodiments, the UE truncates only the MR of the last cell included in the MAC CE. For example, if cell 1 and cell 2 information is included in the MR MAC CE, truncation is only for cell 2.

Alternatively, in some embodiments, the UE can truncate the MR for multiple cells included in the MAC CE. For example, if cell 1 and cell 2 information is included in the MR MAC CE, truncation of beams can be for both cell 1 and cell 2 or any other cell. In this approach, the UE tries to maximize reporting of as many cells as possible by truncating the number of beams of the cells to be reported.

At operation 560, the UE transmits the generated MR MAC CE or truncated MR MAC CE to the gNB.

Although FIG. 5 illustrates one example method for generating an MR MAC CE for event-triggered L1-measurements reporting 500, various changes may be made to FIG. 5. For example, while shown as a series of operations, various operations in FIG. 5 could overlap, occur in parallel, occur in a different order, occur any number of times, be omitted, or replaced by other operations.

In some embodiments, the MR MAC CE can report a MR for beams of at most one cell in a single MAC CE.

In some embodiments, event-triggered L1-measurements reporting is triggered for at least one beam of a cell. In some embodiments, event-triggered L1-measurements reporting is triggered if an event configured for the beam is met and continues to be met for a time interval equal to ‘time to trigger’. This may also be referred to as a threshold time.

In some embodiments, if the UL grant can accommodate an MR MAC CE including event-triggered L1-measurements reporting information of beams of a cell, the UE generates an MR MAC CE including L1-measurements reporting information of the beams of the cell. In embodiments such as these, the L1-RSRP or SINR of up to N beams is included in the MAC CE. N is configured by the network and is equal to a maximum number of beams whose information can be included in the report. If X is the number of beams in a cell, the number of beams (K) per cell whose information can be included in the report may be equal to a minimum of (N, X). N, or the number of beams whose information can be included in the report equals the number of beams for which the event is met, plus other beams for which the event is not met (for the case N is greater than the number of beams for which the event is met), if any. If the number of other beams for which event is not met is greater than ‘N (or K)—number of beams for which event is met’, the UE selects the best ‘N (or K)—number of beams for which the event is met’ of other beams to report in the MR MAC CE.

In some embodiments, if the UL grant cannot accommodate an MR MAC CE including event-triggered L1-measurements reporting information of beams of a cell, the UE truncates the number of beams of the cell to be reported in the MR MAC CE. The UE may exclude reporting some beams in the MR of a cell if the UL grant size is insufficient. For example, if N is 4 (i.e., the UE can report information of up to 4 beams), the UE may report information of a number of beams less than 4. During truncation, the UE prioritizes reporting of beams for which the event is met over the beams for which the event is not met. For example, if N is 4 and for beams b1 and b2 the event is met, the UE prioritizes reporting beams b1 and b2 over other beams if the UL grant size is insufficient.

In some embodiments, the UE always includes the beams for which the event is met and truncates only other beam info; or alternatively, in some embodiments, the UE may also truncate beam information of beams for which the event is met after truncating other beam information if the UL grant size is not insufficient. For example, if N is 4 (i.e., the UE can report information of up to 4 beams) and the event is met for beams b1, b2 and b3, the UE may report information of b1 if the UL grant size is insufficient to include information of b2 and b3. The UE may truncate beam information of beams based on the time reporting was triggered (e.g., a beam for which reporting was triggered later may be truncated [i.e., the UE may include beam information of beams in ascending order (earliest to latest) of reporting time]). Alternatively, the UE may truncate beam information of beams based on the time reporting was triggered (e.g., beam for which reporting was triggered earlier may be truncated [i.e., the UE may include beam information of beams in descending order (latest to earliest) of reporting time]).

In some embodiments, event-triggered L1-measurements reporting is triggered for at least one beam of a plurality of cells. In some embodiments, event-triggered L1-measurements reporting is triggered if the event configured for the beam is met and continues to be met for a time interval equal to ‘time to trigger’. This may also be referred to as a threshold time.

In some embodiments, a UL grant becomes available. If the UL grant size is insufficient to accommodate L1-measurements reporting information of beams of all of the cells, the UE prioritizes including L1-measurements reporting information of beams of cells for which the event was met earlier. For example, event-triggered L1-measurements reporting is triggered for at least one beam of Cell 1 and Cell 2. Reporting was triggered for a beam of cell 1 at time T1 and reporting was triggered for a beam of cell 2 at time T2 where T2 is greater than T1. If the UL grant size is insufficient, the UE includes L1-measurements reporting information of beams of Cell 1 and does not include L1-measurements reporting information of beams of Cell 2.

In some embodiments, a UL grant becomes available. If the UL grant size is insufficient to accommodate L1-measurements reporting information of beams of all of the cells, the UE prioritizes inclusion of L1-measurements reporting information of beams of cells for which the event was met later. For example, event-triggered L1-measurements reporting is triggered for at least one beam of Cell 1 and Cell 2. Reporting was triggered for a beam of cell 1 at time T1 and reporting was triggered for a beam of cell 2 at time T2 where T2 is greater than T1. If the UL grant size is insufficient, the UE includes L1-measurements reporting information of beams of Cell 2 and does not include L1-measurements reporting information of beams of Cell 1.

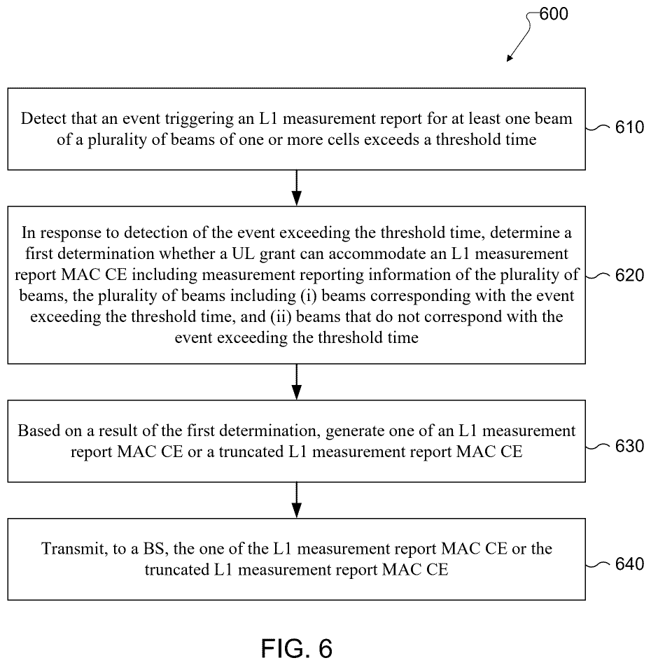

FIG. 6 illustrates an example method for transmitting and receiving an MR MAC CE 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method for transmitting and receiving a MR MAC CE could be used without departing from the scope of this disclosure.

In the example of FIG. 6, the method 600 begins at step 610. At step 610, a UE (such as UE 116 of FIG. 1) detects that an event triggering an L1 measurement report for at least one beam of a plurality of beams of one or more cells exceeds a threshold time.

At step 620, in response to detection of the event exceeding the threshold time, the UE determines a first determination whether a UL grant can accommodate an L1 measurement report MAC CE including measurement reporting information of the plurality of beams, the plurality of beams including (i) beams corresponding with the event exceeding the threshold time, and (ii) beams that do not correspond with the event exceeding the threshold time.

At step 630, based on a result of the first determination, the UE generates one of an L1 measurement report MAC CE or a truncated L1 measurement report MAC CE.

At step 640, the UE transmits, to a BS (such as gNB 102 of FIG. 1), the one of the L1 measurement report MAC CE or the truncated L1 measurement report MAC CE.

In some embodiments, the UE may generate the L1 measurement report MAC CE in response to the first determination being affirmative. In embodiments such as these, the UE may generate the L1 measurement report MAC CE to include L1 measurement reporting information for each beam of the plurality of beams.

In some embodiments, the UE may generate the truncated L1 measurement report MAC CE in response to the first determination being negative.

In some embodiments, to generate the truncated L1 measurement report MAC CE, the UE may (i) select a subset of cells of the one or more cells, and (ii) include measurement reporting information for each beam of the plurality of beams corresponding with the subset of cells within the truncated L1 measurement report MAC CE.

In some embodiments, to generate the truncated L1 measurement report MAC CE, the UE may prioritize inclusion of measurement reporting information for beams corresponding with the event exceeding the threshold time over inclusion of measurement reporting information for beams that do not correspond with the event exceeding the threshold time within the truncated L1 measurement report MAC CE.

In some embodiments, to generate the truncated L1 measurement report MAC CE, the UE may include measurement reporting information for each beam corresponding with the event exceeding the threshold time within the truncated L1 measurement report MAC CE.

In some embodiments, to generate the truncated L1 measurement report MAC CE, the UE may (i) determine a second determination whether the UL grant can accommodate inclusion of reporting information for each beam corresponding with the event exceeding the threshold time within the truncated L1 measurement report MAC CE, and (ii) in response to the second determination being negative, excluding reporting information for at least one beam corresponding with the event exceeding the threshold time from the truncated L1 measurement report MAC CE.

In some embodiments, to generate the truncated L1 measurement report MAC CE, the UE may prioritize inclusion of measurement reporting information for beams corresponding with the event exceeding the threshold time earlier over inclusion of measurement reporting information for beams corresponding with the event exceeding the threshold time later within the truncated L1 measurement report MAC CE.

Although FIG. 6 illustrates one example method for transmitting and receiving an MR MAC CE 600, various changes may be made to FIG. 6. For example, while shown as a series of steps, various steps in FIG. 6 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a processor configured to:
detect that an event triggering a layer 1 (L1) measurement report for at least one beam of a plurality of beams of one or more cells exceeds a threshold time;
in response to detection of the event exceeding the threshold time, determine a first determination whether an uplink (UL) grant can accommodate an L1 measurement report medium access control (MAC) control element (CE) including measurement reporting information of the plurality of beams, the plurality of beams including (i) beams corresponding with the event exceeding the threshold time, and (ii) beams that do not correspond with the event exceeding the threshold time; and
based on a result of the first determination, generate one of an L1 measurement report MAC CE or a truncated L1 measurement report MAC CE; and
a transceiver operably coupled to the processor, the transceiver configured to transmit, to a base station (BS), the one of the L1 measurement report MAC CE or the truncated L1 measurement report MAC CE.

2. The UE of claim 1, wherein the processor is further configured to generate the L1 measurement report MAC CE in response to the first determination being affirmative, and
wherein the L1 measurement report MAC CE is generated to include L1 measurement reporting information for each beam of the plurality of beams.

3. The UE of claim 1, wherein the processor is further configured to generate the truncated L1 measurement report MAC CE in response to the first determination being negative.

4. The UE of claim 3, wherein to generate the truncated L1 measurement report MAC CE, the processor is further configured to:
select a subset of cells of the one or more cells; and
include measurement reporting information for each beam of the plurality of beams corresponding with the subset of cells within the truncated L1 measurement report MAC CE.

5. The UE of claim 3, wherein to generate the truncated L1 measurement report MAC CE, the processor is further configured to prioritize inclusion of measurement reporting information for beams corresponding with the event exceeding the threshold time over inclusion of measurement reporting information for beams that do not correspond with the event exceeding the threshold time within the truncated L1 measurement report MAC CE.

6. The UE of claim 5, wherein to generate the truncated L1 measurement report MAC CE, the processor is further configured to include measurement reporting information for each beam corresponding with the event exceeding the threshold time within the truncated L1 measurement report MAC CE.

7. The UE of claim 5, wherein to generate the truncated L1 measurement report MAC CE, the processor is further configured to:
determine a second determination whether the UL grant can accommodate inclusion of reporting information for each beam corresponding with the event exceeding the threshold time within the truncated L1 measurement report MAC CE; and
in response to the second determination being negative, exclude reporting information for at least one beam corresponding with the event exceeding the threshold time from the truncated L1 measurement report MAC CE.

8. The UE of claim 5, wherein to generate the truncated L1 measurement report MAC CE, the processor is further configured to prioritize inclusion of measurement reporting information for beams corresponding with the event exceeding the threshold time earlier over inclusion of measurement reporting information for beams corresponding with the event exceeding the threshold time later within the truncated L1 measurement report MAC CE.

9. A method of operating a user equipment (UE), the method comprising:
detecting that an event triggering a layer 1 (L1) measurement report for at least one beam of a plurality of beams of one or more cells exceeds a threshold time;
in response to detection of the event exceeding the threshold time, determining a first determination whether an uplink (UL) grant can accommodate an L1 measurement report medium access control (MAC) control element (CE) including measurement reporting information of the plurality of beams, the plurality of beams including (i) beams corresponding with the event exceeding the threshold time, and (ii) beams that do not correspond with the event exceeding the threshold time;
based on a result of the first determination, generating one of an L1 measurement report MAC CE or a truncated L1 measurement report MAC CE; and
transmitting, to a base station (BS), the one of the L1 measurement report MAC CE or the truncated L1 measurement report MAC CE.

10. The method of claim 9, wherein:
the L1 measurement report MAC CE is generated in response to the first determination being affirmative, and
the L1 measurement report MAC CE is generated to include L1 measurement reporting information for each beam of the plurality of beams.

11. The method of claim 9, wherein the truncated L1 measurement report MAC CE is generated in response to the first determination being negative.

12. The method of claim 11, wherein to generate the truncated L1 measurement report MAC CE, the method further comprises:
selecting a subset of cells of the one or more cells; and
including measurement reporting information for each beam of the plurality of beams corresponding with the subset of cells within the truncated L1 measurement report MAC CE.

13. The method of claim 11, wherein to generate the truncated L1 measurement report MAC CE, the method further comprises prioritizing inclusion of measurement reporting information for beams corresponding with the event exceeding the threshold time over inclusion of measurement reporting information for beams that do not correspond with the event exceeding the threshold time within the truncated L1 measurement report MAC CE.

14. The method of claim 13, wherein to generate the truncated L1 measurement report MAC CE, the method further comprises including measurement reporting information for each beam corresponding with the event exceeding the threshold time within the truncated L1 measurement report MAC CE.

15. The method of claim 13, wherein to generate the truncated L1 measurement report MAC CE, the method further comprises:
determining a second determination whether the UL grant can accommodate inclusion of reporting information for each beam corresponding with the event exceeding the threshold time within the truncated L1 measurement report MAC CE; and
in response to the second determination being negative, excluding reporting information for at least one beam corresponding with the event exceeding the threshold time from the truncated L1 measurement report MAC CE.

16. The method of claim 13, wherein to generate the truncated L1 measurement report MAC CE, the method further comprises prioritizing inclusion of measurement reporting information for beams corresponding with the event exceeding the threshold time earlier over inclusion of measurement reporting information for beams corresponding with the event exceeding the threshold time later within the truncated L1 measurement report MAC CE.

17. A non-transitory computer readable medium embodying a computer program comprising program code that, when executed by a processor of a device, causes the device to:
detect that an event triggering a layer 1 (L1) measurement report for at least one beam of a plurality of beams of one or more cells exceeds a threshold time;
in response to detection of the event exceeding the threshold time, determine a first determination whether an uplink (UL) grant can accommodate an L1 measurement report medium access control (MAC) control element (CE) including measurement reporting information of the plurality of beams, the plurality of beams including (i) beams corresponding with the event exceeding the threshold time, and (ii) beams that do not correspond with the event exceeding the threshold time;
based on a result of the first determination, generate one of an L1 measurement report MAC CE or a truncated L1 measurement report MAC CE; and
transmit, to a base station (BS), the one of the L1 measurement report MAC CE or the truncated L1 measurement report MAC CE.

18. The non-transitory computer readable medium of claim 17, wherein:
the L1 measurement report MAC CE is generated in response to the first determination being affirmative, and
the L1 measurement report MAC CE is generated to include L1 measurement reporting information for each beam of the plurality of beams.

19. The non-transitory computer readable medium of claim 17, wherein the truncated L1 measurement report MAC CE is generated in response to the first determination being negative.

20. The non-transitory computer readable medium of claim 17, wherein to generate the truncated L1 measurement report MAC CE, the program code, when executed by the processor of the device, further causes the device to prioritize inclusion of measurement reporting information for beams corresponding with the event exceeding the threshold time over inclusion of measurement reporting information for beams that do not correspond with the event exceeding the threshold time within the truncated L1 measurement report MAC CE.
